(19) United States
(12) Patent Application Publication
(10) Pub. No.: US 2026/0157576 A1
(43) Pub. Date: Jun. 11, 2026

(54) AUTOMATED COOKING DEVICE

(71) Applicant: TECHMAGIC INC., Tokyo (JP)

(72) Inventors: Eiji Ishiwata, Tokyo (JP); Keisuke Sakima, Tokyo (JP)

(21) Appl. No.: 19/179,633

(22) Filed: Apr. 15, 2025

Related U.S. Application Data
(63) Continuation of application No. PCT/JP2024/037743, filed on Oct. 23, 2024.

(30) Foreign Application Priority Data
Apr. 16, 2024 (JP) 2024-066377

(51) Int. Cl. A47J 44/00; A47J 27/14

(52) U.S. Cl. CPC A47J 44/00; A47J 27/14

(57) ABSTRACT

Provided is an automated cooking device which realizes trained skills of a stir operation by a cook in a more natural and advanced manner. A container holding unit 200 configured to rotatably hold a cooking container 300 including a bottomed cylindrical container body 310 configured to contain an ingredient I and a stir member 320 configured to stir the ingredient I contained in the container body 310 has a container rotating shaft 222 configured to engage with the container body 310 to transmit a container rotation torque to the container body 310 to cause the container body 310 to rotate around a container body central axis AC and a stir member rotating shaft 225 configured to rotate independently of the container rotating shaft 222, and a magnetic coupling mechanism configured to transmit a stir member rotation torque in a non-contact manner between the stir member rotating shaft 225 of the container holding unit 200 and the stir member 320 of the cooking container 300 is formed.

### TECHNICAL FIELD

The present invention relates to an automated cooking device, and particularly to an automated cooking device for stirring and cooking an ingredient contained in a bottomed cylindrical cooking container.

### BACKGROUND ART

In recent years, in the food industry, automation of cooking operations has been more and more developed in view of circumstances, such as securing cooks, maintaining cooking skills, and improving cooking environments.

In this regard, there has been hitherto known an automated cooking device comprising: a container holding unit configured to hold a bottomed cylindrical cooking container; a pivot unit configured to allow the cooking container held by the container holding unit to pivot such that the cooking container can rise and fall between a front area and a back area of a cooking counter; and a control unit configured to control driving of the container holding unit and the pivot unit, the automated cooking device being configured to at least stir and cook an ingredient contained in the cooking container, in which the cooking container includes a stir member provided on an inner bottom surface or an inner side surface of a container body in such a manner as to protrude toward an interior space of the container body (for example, see Patent Literature 1).

### PRIOR ART DOCUMENT

### Patent Literature

Patent Literature 1: JP2022-175791A

### SUMMARY OF INVENTION

### Technical Problem

However, in the above-mentioned automated cooking device, the stir member rotates integrally with the container body, so that there is still room for further improvement in order to realize trained skills of a stir operation by a cook.

Thus, the present invention is to solve the problem of the prior art as described above. In other words, it is an object of the present invention to provide an automated cooking device which realizes trained skills of a stir operation by a cook in a more natural and advanced manner.

### Solution to Problem

The invention according to claim 1 is to solve the above problem by an automated cooking device comprising: a cooking container including a bottomed cylindrical container body configured to contain an ingredient and a stir member configured to stir the ingredient contained in the container body; and a container holding unit configured to rotatably hold the cooking container, the automated cooking device being configured to stir and cook the ingredient contained in the cooking container, in which the container holding unit has a container rotating shaft configured to engage with the container body of the cooking container to transmit a container rotation torque to the container body to cause the container body to rotate around a container body central axis and a stir member rotating shaft configured to rotate independently of the container rotating shaft, and a magnetic coupling mechanism configured to transmit a stir member rotation torque in a non-contact manner between the stir member rotating shaft of the container holding unit and the stir member of the cooking container is formed.

The invention according to claim 2 of the present application is to further solve the above problem by, in addition to the features of the automated cooking device according to claim 1, the features in which a protrusion portion inserted into a recess portion of the stir member is formed on a bottom surface of the container body, and an annular resin plate configured to slide against the stir member is detachably attached around the protrusion portion of the container body.

The invention according to claim 3 of the present application is to further solve the above problem by, in addition to the features of the automated cooking device according to claim 1, the features in which one of the container body of the cooking container and the container rotating shaft of the container holding unit is provided with an anti-rotation protrusion, and the other of the container body of the cooking container and the container rotating shaft of the container holding unit is provided with an anti-rotation recess groove configured to engage with the anti-rotation protrusion.

The invention according to claim 4 of the present application is to further solve the above problem by, in addition to the features of the automated cooking device according to any one of claim 1 to claim 3, the features in which the container body of the cooking container is formed by a side surface made of a magnetic material and configured to be inductively heated from a container heating unit and a bottom surface including a non-magnetic region.

### Effects of Invention

According to the automated cooking device of the invention according to claim 1, the container holding unit has a container rotating shaft configured to engage with the container body of the cooking container to transmit a container rotation torque to the container body to cause the container body to rotate around a container body central axis and a stir member rotating shaft configured to rotate independently of the container rotating shaft, and a magnetic coupling mechanism configured to transmit a stir member rotation torque in a non-contact manner between the stir member rotating shaft of the container holding unit and the stir member of the cooking container is formed, which allows the stir member to be rotatable independently of the container body, so that the stir member is allowed to rotate faster than the container body or slower than the container body, thereby realizing trained skills of a stir operation by a cook in a more natural and advanced manner, and thus various foods can be cooked.

Further, a magnetic coupling mechanism configured to transmit a stir member rotation torque in a non-contact manner between the stir member rotating shaft of the container holding unit and the stir member of the cooking container is formed, and consequently in comparison with a case in which the stir member is fixed to the container body by screwing, etc., a bottom portion of the container body has a simpler shape, which can eliminate the risk of an ingredient remaining at an attachment portion between the stir member and the container body and also make it easy to attach and detach the stir member relative to the container body during maintenance.

According to the automated cooking device of the invention according to claim 2, in addition to the effects produced by the automated cooking device of the invention according to claim 1, a protrusion portion inserted into a recess portion of the stir member is formed on a bottom surface of the container body, and an annular resin plate configured to slide against the stir member is detachably attached around the protrusion portion of the container body, thereby reducing the sliding resistance between the container body and the stir member, and thus the stir member can be rotated more reliably and at a higher speed relative to the container body.

According to the automated cooking device of the invention according to claim 3, in addition to the effects produced by the automated cooking device of the invention according to claim 1, one of the container body of the cooking container and the container rotating shaft of the container holding unit is provided with an anti-rotation protrusion, and the other of the container body of the cooking container and the container rotating shaft of the container holding unit is provided with an anti-rotation recess groove configured to engage with the anti-rotation protrusion, so that by merely engaging the anti-rotation protrusion with the anti-rotation recess groove, the cooking container and the container holding unit are positioned and held relative to each other, and thus a container body rotation torque can be reliably transmitted from the container holding unit to the container body of the cooking container using a simple structure.

According to the automated cooking device of the invention according to claim 4, in addition to the effects produced by the automated cooking device of the invention according to claim any one of claim 1 to claim 3, the container body of the cooking container is formed by a side surface made of a magnetic material and configured to be inductively heated from a container heating unit and a bottom surface including a non-magnetic region, so that the magnetic circuit formed by the side surface of the container body and the container heating unit and the magnetic circuit formed within the magnetic coupling are separate from each other, and thus it is possible to reliably achieve both rotation of the container body and the stir member by the container holding unit and inductive heating by the container heating unit.

### BRIEF DESCRIPTION OF DRAWINGS

FIG. 1 is a perspective view of an automated cooking device 10 according to a first embodiment of the present invention.

FIG. 2 is an assembly diagram of main parts of the automated cooking device 10 as illustrated in FIG. 1.

FIG. 3A is a partial cross-sectional view of the left side of the automated cooking device 10 as illustrated in FIG. 1.

FIG. 3B is an enlarged view of IIIB of FIG. 3A.

FIG. 4A is a schematic diagram illustrating a magnetic circuit provided in the automated cooking device 10 as illustrated in FIG. 1.

FIG. 4B is an enlarged view of IVB of FIG. 4A.

FIG. 5 is an exploded view of a stir member 320 as illustrated in FIG. 2.

FIG. 6A is a schematic diagram illustrating a state in which an ingredient is fed into a cooking container.

FIG. 6B is a schematic diagram illustrating a state in which a stir member stirs the ingredient.

FIG. 7 is an assembly diagram of a main part of the automated cooking device 10 according to a second embodiment of the present invention.

FIG. 8A is a partial cross-sectional view of the left side of the automated cooking device 10 as illustrated in FIG. 7.

FIG. 8B is an enlarged view of VIIIB of FIG. 8A.

FIG. 9 is an exploded view of the stir member 320 as illustrated in FIG. 7.

### DESCRIPTION OF EMBODIMENTS

The present invention may be embodied in any way as long as an automated cooking device according to the present invention comprises: a cooking container including a bottomed cylindrical container body configured to contain an ingredient and a stir member configured to stir the ingredient contained in the container body; and a container holding unit configured to rotatably hold the cooking container, the automated cooking device being configured to stir and cook the ingredient contained in the cooking container, in which the container holding unit has a container rotating shaft configured to engage with the container body of the cooking container to transmit a container rotation torque to the container body to cause the container body to rotate around a container body central axis and a stir member rotating shaft configured to rotate independently of the container rotating shaft, and a magnetic coupling mechanism configured to transmit a stir member rotation torque in a non-contact manner between the stir member rotating shaft of the container holding unit and the stir member of the cooking container is formed, thereby realizing trained skills of a stir operation by a cook in a more natural and advanced manner.

For example, the automated cooking device according to the present invention is to be installed mainly in a restaurant store, but an installation location of the automated cooking device according to the present invention is not limited to this and may include a food court, an office, a family house, etc.

For example, an ingredient cooked by the automated cooking device according to the present invention may be any food, such as rice, noodles, vegetables, fish, grains, and various seasonings.

For example, the automated cooking device according to the present embodiment may include a container heating unit configured to inductively heat the cooking container so as to heat and cook an ingredient contained in the cooking container, but may also merely stir and cook an ingredient contained in the cooking container without heating the same.

Then, when an ingredient contained in the cooking container is stirred and cooked without being heated, the entirety of the cooking container may be made of a non-magnetic material.

For example, the rotating shaft of the stir member of the cooking container according to the present invention may be the same as or different from the container body rotating shaft.

### Embodiment 1

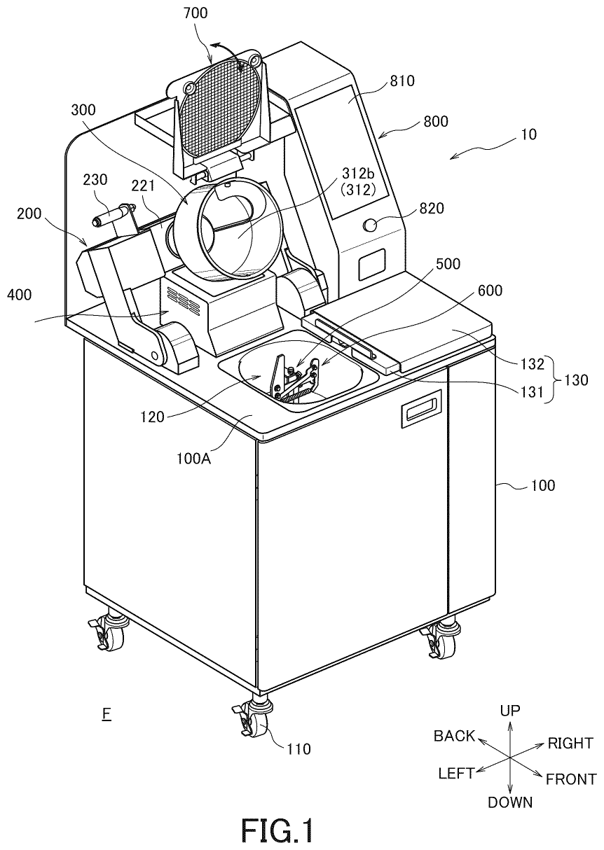

In the following, an automated cooking device 10 according to a first embodiment of the present invention will be described with reference to FIG. 1 to FIG. 6B.

### <1. Basic Configuration of Automated Cooking Device>

First, a basic configuration of the automated cooking device 10 will be described with reference to FIG. 1 which is a perspective view of the automated cooking device.

First, as illustrated in FIG. 1, the automated cooking device 10 is movably provided on a floor surface F.

Then, the automated cooking device 10 includes a cooking counter 100 configured to serve as a base, a container holding unit 200 placed on the cooking counter 100, a cooking container 300 rotatably held by the container holding unit 200, a container heating unit 400 placed on the cooking counter 100 and configured to inductively heat the cooking container 300, a container washing unit 500 and a scraping unit 600 provided to the cooking counter 100, a cover 700 configured to allow an opening face of the cooking container 300 to be opened or closed, and a control unit 800 placed on the cooking counter 100 and configured to carry out integrated control of the entirety of the automated cooking device 10, and the automated cooking device 10 is configured to cook a food in an automated manner by stirring and cooking an ingredient contained in the cooking container 300.

The cooking counter 100 includes a plurality of casters 110 provided to a bottom surface thereof, a sink 120 formed in a front area of a top surface 100A, and a plate table 130 configured to allow the sink 120 to be opened or closed and on which a plate or the like is placed.

The plate table 130 includes: a board for plating 131 slidable in a left and right direction and configured to close an opening face of the sink 120 and on which a plate on which a stirred and cooked ingredient is to be plated up is placed; and a board storage member 132 configured to store the board for plating 131 and on which a plate or the like is to be temporarily placed.

The container heating unit 400 is placed on a back side of the sink 120 and configured to heat a side surface 312 of the cooking container 300 by inductive heating.

The container washing unit 500 is installed in the interior of the sink 120 and configured to discharge rinse water or the like onto the cooking container 300.

The scraping unit 600 is provided in the interior of the sink 120 and configured to remove a dirt, such as a burn adhering to the cooking container 300.

The cover 700 is pivotable around a cover central axis extending in the left and right direction.

A large part of the cover 700 is configured to have a mesh shape such that the interior of the cooking container 300 can be viewed while the opening face of the cooking container 300 is closed.

The control unit 800 includes a control panel 810 for operations and an emergency stop button 820 for carrying out an emergency stop of a cooking operation of the automated cooking device 10 and is configured to control driving of each unit based on an input to the control panel 810.

The control unit 800 further includes at least a processor, a main memory, an auxiliary memory, and a network interface which are unillustrated.

Each component constituting the control unit 800 is connected via a bus which is a data transmission path between such components.

Note that the processor is implemented as a CPU (Central Processing Unit) or a GPU (Graphics Processing Unit) and carries out various processing according to programs stored in the main memory or the auxiliary memory.

The main memory is constituted by an SRAM (static RAM (Random Access Memory)), a DRAM (Dynamic RAM), a flash memory or the like and temporarily stores data required for calculation processing by the control unit 800.

The auxiliary memory is implemented as an HDD (Hard Disk Drive, an SSD (Solid State Drive), a removable medium, such as a memory card, or a ROM (Read-Only Memory) and includes a recording medium.

The network interface communicates with other terminals, systems or the like via a communication network including the internet.

### <2. Details of Container Holding Unit and Cooking Container>

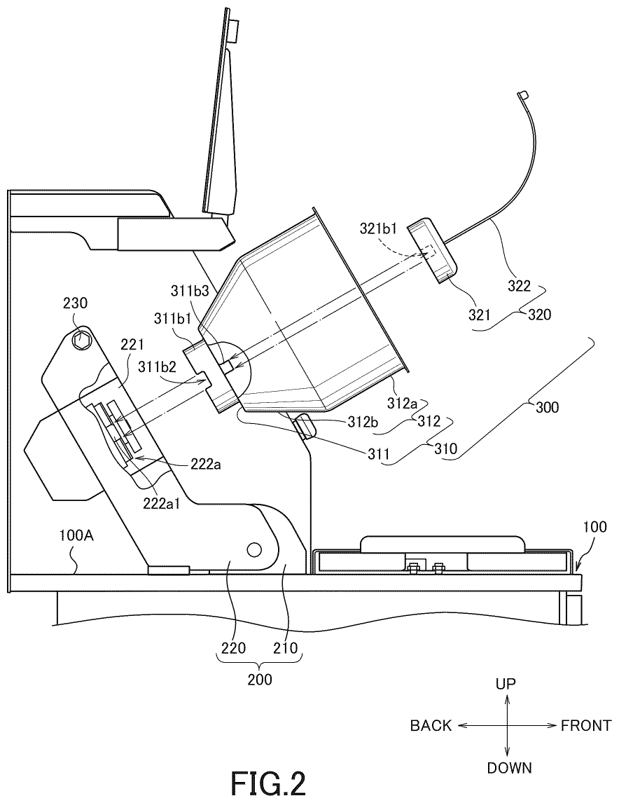

Next, details of the container holding unit 200 and the cooking container 300 will be described with reference to FIG. 2 to FIG. 5.

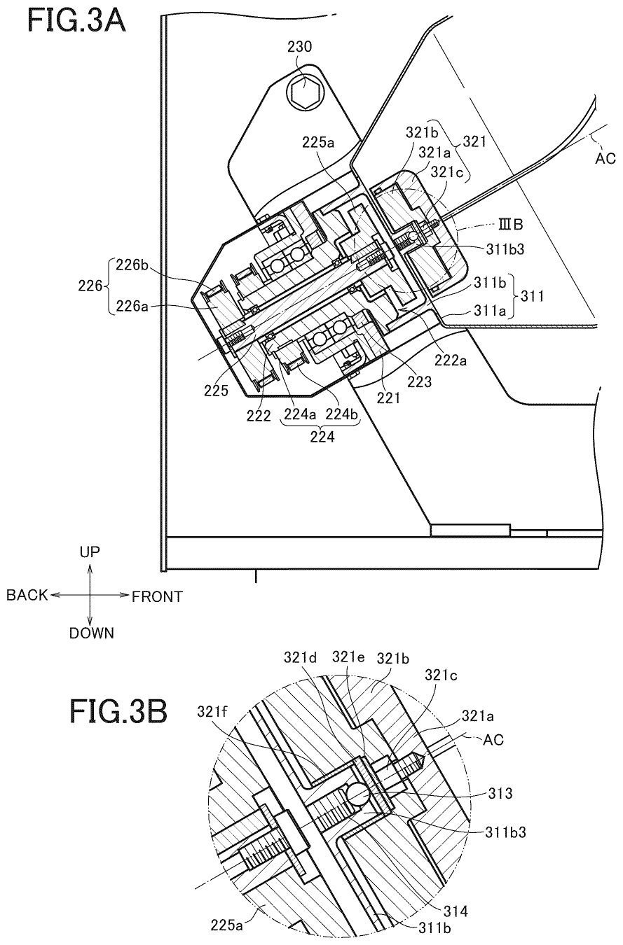

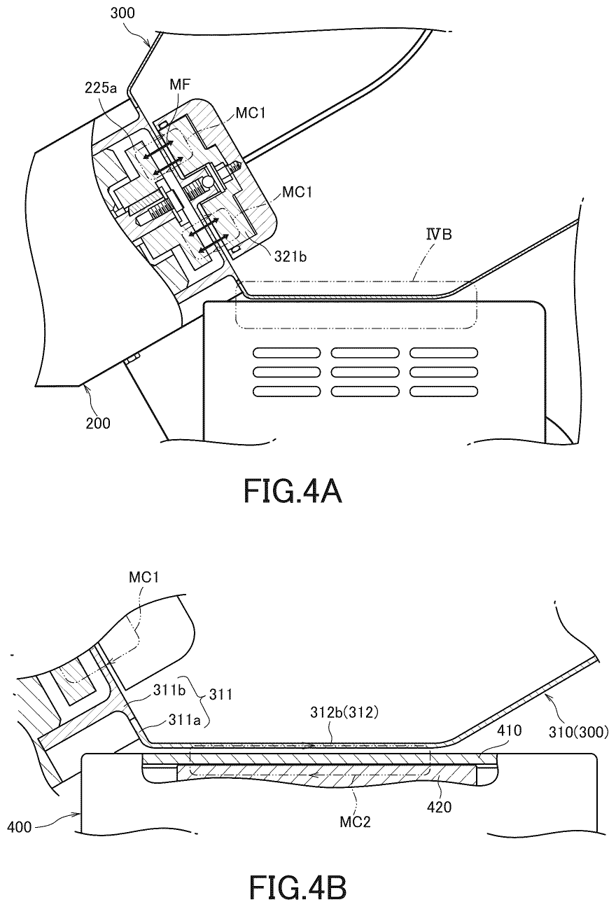

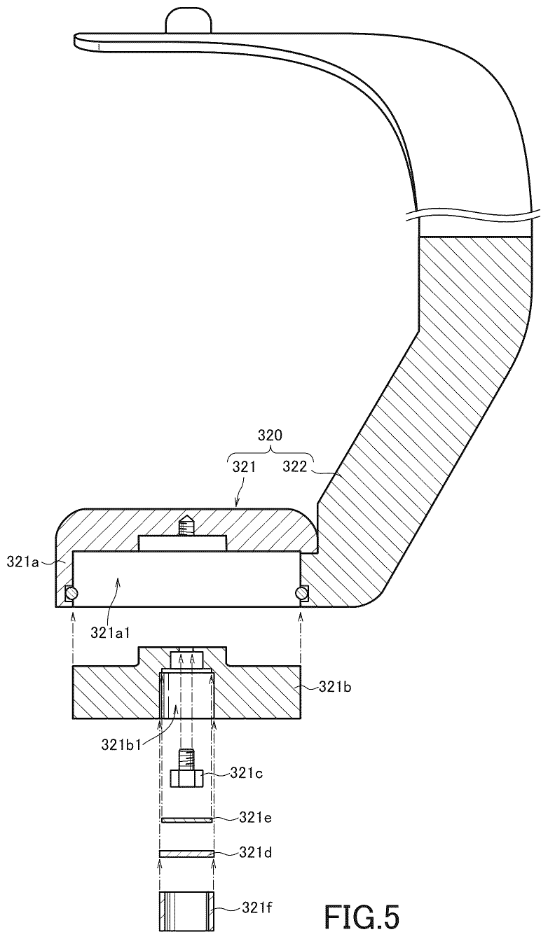

FIG. 2 is an assembly diagram of main parts of the automated cooking device 10 as illustrated in FIG. 1, FIG. 3A is a partial cross-sectional view of the left side of the automated cooking device 10 as illustrated in FIG. 1, FIG. 3B is an enlarged view of IIIB of FIG. 3A, FIG. 4A is a schematic diagram illustrating a magnetic circuit provided in the automated cooking device 10 as illustrated in FIG. 1, FIG. 4B is an enlarged view of IVB of FIG. 4A, and FIG. 5 is an exploded view of a stir member 320 as illustrated in FIG. 2.

Note that in FIG. 2, the board for plating 131 slides so that the opening face of the sink 120 is closed.

### <2.1. Container Holding Unit>

As illustrated in FIG. 2, etc., the container holding unit 200 includes a base portion 210 provided on the top surface 100A of the cooking counter 100, a pivot portion 220 configured to be pivotable relative to the base portion 210 in the front and back direction, and a handle 230 (see also FIG. 1) provided to the pivot portion 220 and configured to be grasped by a user of the automated cooking device 10.

Thus, according to this embodiment, a user of the automated cooking device 10 grasps the handle 230 to move the pivot portion 220 back and forth relative to the base portion 210, whereby the cooking container 300 held in the container holding unit 200 rises and falls back and forth.

The pivot portion 220 holds the cooking container 300 rotatable around a container body central axis AC extending in a container depth direction of the cooking container 300.

As illustrated in FIG. 3A, etc., the pivot portion 220 includes a housing 221 coupled to the base portion 210 (see also FIG. 1 and FIG. 2), a cylindrical container rotating shaft 222 inserted in the housing 221, an oil seal 223 provided between the housing 221 and the container rotating shaft 222 in such a manner as to support the container rotating shaft 222 rotatably relative to the housing 221, a first drive unit 224 configured to rotate the container rotating shaft 222, a stir member rotating shaft 225 inserted in the container rotating shaft 222 and arranged concentrically with the container rotating shaft 222 in such a manner as to rotate independently of each other, and a second drive unit 226 configured to rotate the stir member rotating shaft 225.

The container rotating shaft 222 is provided with a flange portion 222a on a front end side, and the flange portion 222a is provided with an anti-rotation protrusion 222a1 protruding circumferentially as illustrated in FIG. 2.

The first drive unit 224 is composed of an unillustrated first drive motor, a timing pulley 224a attached to a back end portion of the container rotating shaft 222, and a timing belt 224b spanned between the timing pulley 224a and the unillustrated first drive motor and configured to transmit the power of the first drive motor to the timing pulley 224a.

The stir member rotating shaft 225 is provided with a magnetized disk-shaped driving side ferromagnetic body 225a at a front end side thereof.

The driving side ferromagnetic body 225a has north poles and south poles arranged alternately in a circumferential direction.

In other words, the driving side ferromagnetic body 225a according to this embodiment has four pairs of north and south poles.

Further, the axis of the stir member rotating shaft 225 coincides with the axis of the container rotating shaft 222.

The second drive unit 226 is composed of an unillustrated second drive motor, a timing pulley 226a attached to a back end portion of the stir member rotating shaft 225, and a timing belt 226b spanned between the timing pulley 226a and the unillustrated second drive motor and configured to transmit the power of the second drive motor to the timing pulley 226a.

### <2.2. Cooking Container>

The cooking container 300 includes a container body 310 configured to contain an ingredient and the stir member 320 attached to the container body 310 and configured to stir the ingredient contained in the container body 310.

### <2.2.1. Container Body>

As illustrated in FIG. 2, the container body 310 is formed of a disk-shaped bottom surface 311 and a cylindrical side surface 312 connected to an outer circumferential end of the bottom surface 311.

As illustrated in FIG. 3A, the bottom surface 311 is formed of an annular magnetic region 311a made of a magnetic material and continuous with the side surface 312 and a disk-shaped non-magnetic member (non-magnetic region) 311b welded to an inner circumferential edge of the magnetic region 311a and structurally integral with the magnetic region 311a.

In other words, the bottom surface 311 of the container body 310 according to this embodiment includes a non-magnetic region.

As illustrated in FIG. 2, the non-magnetic member 311b has a cylindrical tubular portion 311b1 extending outward of the container body 310 (i.e. toward the container holding unit 200).

As illustrated in FIG. 2, the tubular portion 311b1 is provided with an anti-rotation recess groove 311b2 configured to engage with the anti-rotation protrusion 222a1 of the container holding unit 200.

Thus, the anti-rotation protrusion 222a1 of the container rotating shaft 222 engages with the anti-rotation recess groove 311b2 provided to the container body 310 of the cooking container 300, whereby a container rotation torque is transmitted from the container rotating shaft 222 to the container body 310 and the container body 310 rotates around the container body rotation axis CA illustrated in FIG. 3A, etc.

In other words, the container rotating shaft 222 is configured to engage with the container body 310 of the cooking container 300 to transmit a container rotation torque to the container body 310, thereby causing the container body 310 to rotate around the container body central axis AC.

Further, as illustrated in FIG. 2, FIG. 3A, and FIG. 3B, the non-magnetic member 311b has a cylindrical protrusion portion 311b3 protruding toward inward of the container body 310.

The center of the protrusion portion 311b3 coincides with the container body central axis AC.

Further, as illustrated in FIG. 3B, on an upper surface of the protrusion portion 311b3, a spherical body 313 and a spherical body fixing member 314 are held, and a part of the spherical body 313 is configured to protrude than the protrusion portion 311b3.

The side surface 312 is made of a magnetic material and composed of a cylindrical cylindrical surface 312a and a truncated conical cylindrical inclined surface 312b connecting the cylindrical surface 312a and the bottom surface 311 as illustrated in FIG. 2.

When an ingredient contained in the cooking container 300 is stirred and cooked, the inclined surface 312b is inductively heated while positioned facing and spaced apart from a top plate 410 of the container heating unit 400 as illustrated in FIG. 4B.

In other words, the inclined surface 312b of the side surface 312 of the container body 310 according to this embodiment is made of a magnetic material and configured to be inductively heated from the container heating unit 400.

### <2.2.2. Stir Member>

As illustrated in FIG. 2 and FIG. 5, the stir member 320 is formed of a columnar base portion 321 attached to the container body 310 and a spatula 322 attached to a side surface of the base portion 321.

As illustrated in FIG. 3A, FIG. 3B, FIG. 5, etc., the base portion 321 includes a base portion body 321a composed of a circumferential side surface and a top surface, a magnetized disk-shaped passive side ferromagnetic body 321b inserted into an interior space 321a1 of the base portion body 321a, a fixing screw 321c configured to fix the passive side ferromagnetic body 321b to the base portion body 321a, a flat plate 321d inserted into a recess portion 321b1 of the passive side ferromagnetic body 321b into which a protrusion portion 311b3 of the container body 310 is inserted, a seal member 321e interposed between the flat plate 321d and the fixing screw 321c, and an annular sliding bearing 321f press-fitted into the recess portion 321b1 of the passive side ferromagnetic body 321b.

The passive side ferromagnetic body 321b is positioned relative to the base portion body 321a while inserted into the base portion body 321a.

The passive side ferromagnetic body 321b has north poles and south poles arranged alternately in a circumferential direction and has the same number of north poles and south poles as the driving side ferromagnetic body 225a.

Further, the recess portion 321b1 of the passive side ferromagnetic body 321b is formed at the center of the passive side ferromagnetic body 321b.

Thus, when the protrusion portion 311b3 of the container body 310 is inserted into the recess portion 321b1 of the stir member 320, the stir member 320 rotates around the container body central axis AC.

The flat plate 321d has a disk shape and is in point contact with the spherical body 313 of the container body 310 as illustrated in FIG. 3B.

As illustrated in FIG. 3B, into the sliding bearing 321f, the tubular portion 311b1 of the container body 310 is inserted.

Consequently, as illustrated in FIG. 3A and FIG. 3B, the stir member 320 not only faces and is spaced apart from the bottom surface 311 of the container body 310, but also rotatable and slidable relative to the tubular portion 311b1 of the container body 310 by means of the sliding bearing 321f.

### <2.3. Magnetic Coupling Mechanism>

As described above, the automated cooking device 10 according to this embodiment forms a magnetic coupling mechanism configured to transmit a stir member rotation torque in a non-contact manner between the driving side ferromagnetic body 225a provided in the container holding unit 200 and the passive side ferromagnetic body 321b provided in the cooking container 300.

Thus, the container body 310 and the stir member 320 of the cooking container 300 can rotate around the container body central axis AC independently of each other.

Further, as illustrated in FIG. 4A, between the container holding unit 200 (driving side ferromagnetic body 225a) and the stir member 320 (passive side ferromagnetic body 321b), an attractive force MF due to the magnetic field is generated.

Using the attractive force MF due to the magnetic field, the stir member 320 pushes the container body 310 against the container holding unit 200.

Moreover, as illustrated in FIG. 4B, the bottom surface 311 of the container body 310 is composed of the magnetic region 311a and the non-magnetic region 311b, so that a magnetic circuit MC1 formed between the driving side ferromagnetic body 225a of the container holding unit 200 and the passive side ferromagnetic body 321b of the stir member 320 and a magnetic circuit MC2 formed between the side surface 312 (inclined surface 312b) of the container body 310 and an induction heating coil 420 of the container heating unit 400 are independent of and separated from each other.

### <3. Stirring and Cooking in Cooking Posture>

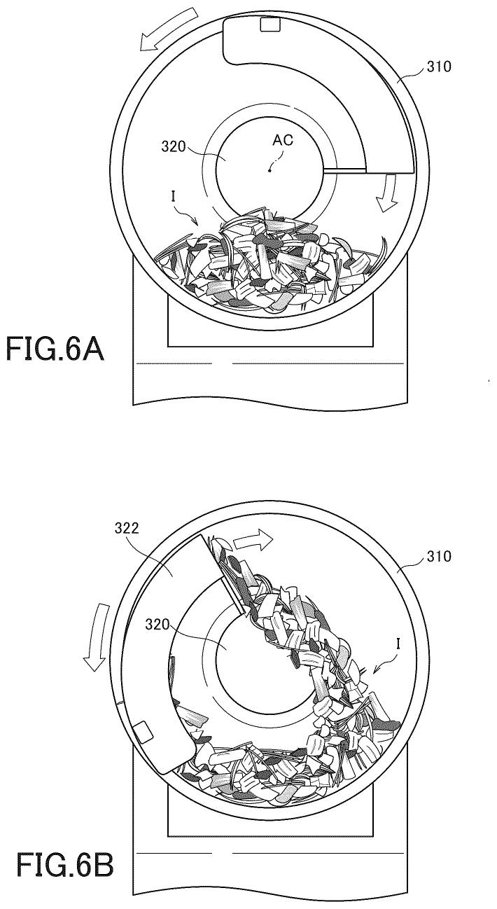

Next, stirring and cooking by the automated cooking device 10 which makes use of the feature in which the container body 310 and the stir member 320 of the cooking container 300 rotate independently of each other will be described with reference to FIG. 6A and FIG. 6B.

FIG. 6A is a schematic diagram illustrating a state in which an ingredient is fed into the cooking container and FIG. 6B is a schematic diagram illustrating a state in which the stir member stirs the ingredient.

After the ingredient I is fed into the container body 310 as illustrated in FIG. 6A, in this embodiment, the container body 310 rotates counterclockwise around the container body central axis AC, while the stir member 320 rotates clockwise around the container body central axis AC.

Accordingly, as illustrated in FIG. 6B, the spatula 322 of the stir member 320 stirs the ingredient I fed into the container body 310.

Note that a rotation speed of the container body 310 and a rotation speed of the stir member 320 can be changed, and set depending upon the food to be cooked.

<4. Effects Produced by Automated cooking Device 10>

According to the automated cooking device 10 according to the first embodiment of the present invention as described above, the container holding unit 200 has a container rotating shaft 222 configured to engage with the container body 310 of the cooking container 300 to transmit a container rotation torque to the container body 310 to cause the container body 310 to rotate around a container body central axis AC and a stir member rotating shaft 225 configured to rotate independently of the container rotating shaft 222, and a magnetic coupling mechanism configured to transmit a stir member rotation torque in a non-contact manner between the stir member rotating shaft 225 of the container holding unit 200 and the stir member 320 of the cooking container 300 is formed, which allows the stir member 320 to be rotatable independently of the container body 310, so that the stir member 320 is allowed to rotate faster than the container body 310 or slower than the container body 310, thereby realizing trained skills of a stir operation by a cook in a more natural and advanced manner, and thus various foods can be cooked.

Further, a magnetic coupling mechanism configured to transmit a stir member rotation torque in a non-contact manner between the stir member rotating shaft 225 of the container holding unit 200 and the stir member 320 of the cooking container 300 is formed, and consequently in comparison with a case in which the stir member 320 is fixed to the container body 310 by screwing, etc., a bottom portion of the container body 310 has a simpler shape, which can eliminate the risk of an ingredient remaining at an attachment portion between the stir member 320 and the container body 310 and also make it easy to attach and detach the stir member 320 relative to the container body 310 during maintenance.

Further, the spherical body 313 in point contact with the recess portion 321b of the stir member 320 is held on the upper surface of the protrusion portion 311b3 and the bottom surface 311 of the container body 310 and the stir member 320 are arranged to face each other in such a manner as to be spaced apart from each other, thereby reducing the sliding resistance between the container body 310 and the stir member 320, and thus the stir member 320 can be rotated more reliably and at a higher speed relative to the container body 310.

Moreover, the container rotating shaft 222 of the container holding unit 200 is provided with an anti-rotation protrusion 222a1, and the container body 310 of the cooking container 300 is provided with an anti-rotation recess groove 311b2 configured to engage with the anti-rotation protrusion, so that by merely engaging the anti-rotation protrusion 222a1 with the anti-rotation recess groove 311b2, the cooking container 300 and the container holding unit 200 are positioned and held relative to each other, and thus a container body rotation torque can be reliably transmitted from the container holding unit 200 to the container body 310 of the cooking container 300 using a simple structure.

In addition, the container body 310 of the cooking container 300 is formed by a side surface 312 made of a magnetic material and configured to be inductively heated from a container heating unit 400 and a bottom surface 311 including a non-magnetic region 311b, so that the magnetic circuit MC2 formed by the side surface 312 of the container body 310 and the container heating unit 400 and the magnetic circuit formed within the magnetic coupling mechanism (magnetic circuit MC1 formed between the container holding unit 200 and the stir member 320) are separate from each other, and thus it is possible to reliably achieve both rotation of the container body 310 and the stir member 320 by the container holding unit 200 and inductive heating by the container heating unit 400.

### Embodiment 2

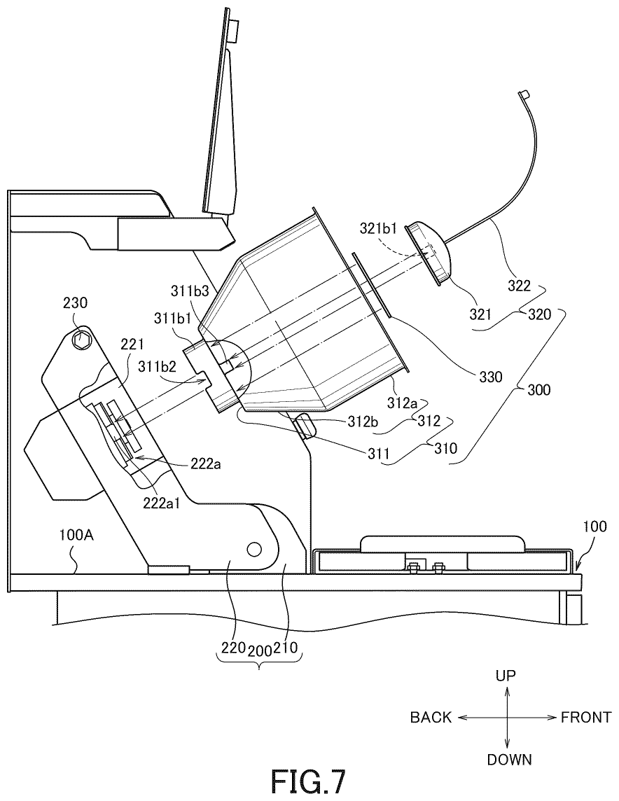

In the following, the automated cooking device 10 according to a second embodiment of the present invention will be described with reference to FIG. 7 to FIG. 9.

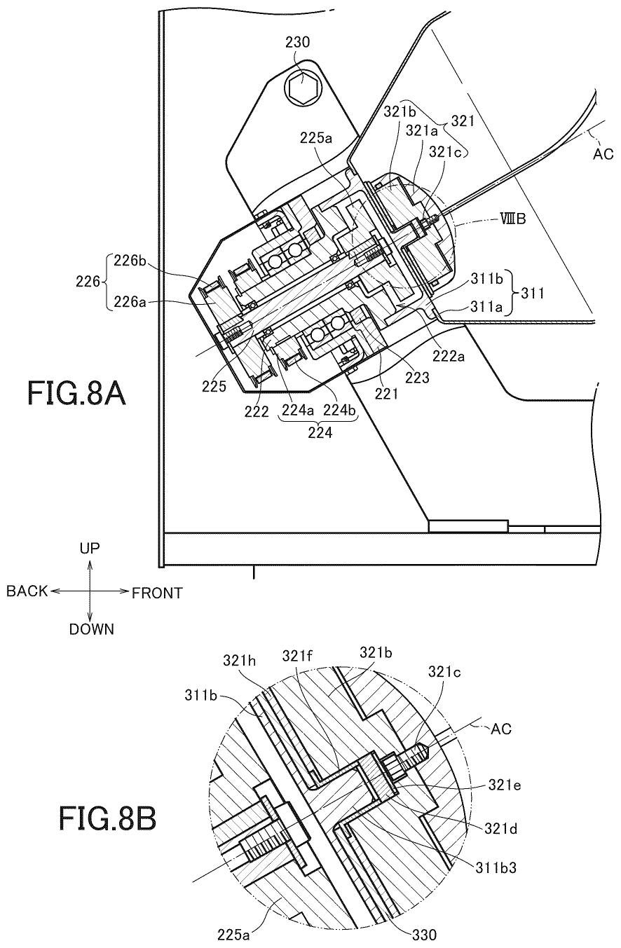

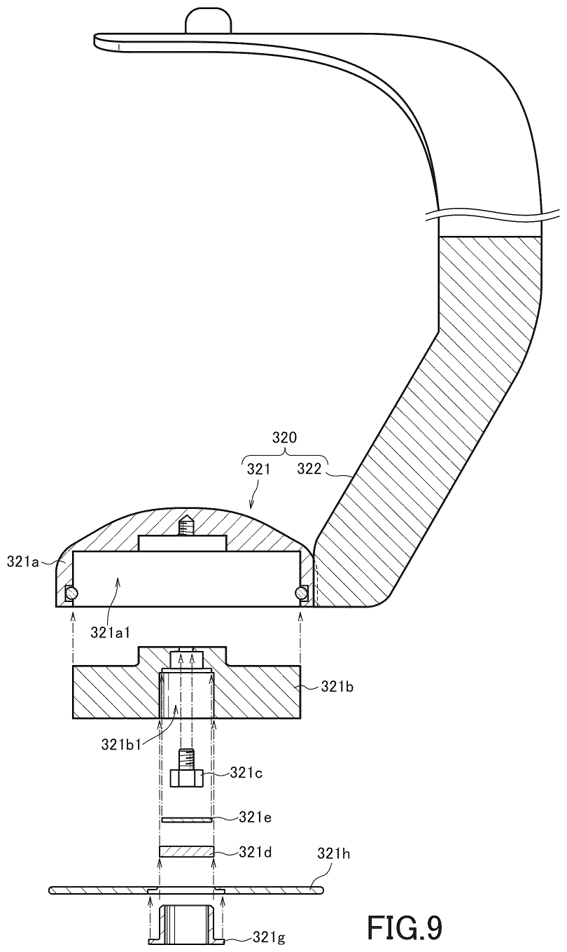

FIG. 7 is an assembly diagram of a main part of the automated cooking device 10 according to the second embodiment of the present invention, FIG. 8A is a partial cross-sectional view of the left side of the automated cooking device 10 as illustrated in FIG. 7, FIG. 8B is an enlarged view of VIIIB of FIG. 8A, and FIG. 9 is an exploded view of the stir member 320 as illustrated in FIG. 7.

Note that the automated cooking device 10 according to the second embodiment has a modified configuration of the cooking container 300 of the automated cooking device 10 according to the first embodiment and many elements common to those of the automated cooking device 10 according to the first embodiment. Therefore, a detailed description on common matters will be omitted.

### <1. Cooking Container>

As illustrated in FIG. 7, the cooking container 300 includes the container body 310 configured to contain an ingredient, the stir member 320 configured to stir the ingredient contained in the container body 310, and an annular resin plate 330 detachably attached to an inner bottom surface of the container body 310.

### <1.1. Container Body>

As illustrated in FIG. 8B, different from the first embodiment, the container body 310 is not provided with a spherical body or a spherical body fixing member.

In other words, in the second embodiment, no spherical body is held on the upper surface of the protrusion portion 311b3 of the container body 310.

### <1.2. Stir Member>

The stir member 320 is fixed by welding or the like to a groove provided to the container body 310.

As illustrated in FIG. 7, the stir member 320 is formed by the cylindrical base portion 321 attached to the container body 310 and the spatula 322 attached to the side surface of the base portion 321.

As illustrated in FIG. 8A, FIG. 8B, and FIG. 9, the base portion 321 includes the base portion body 321a composed of a circumferential side surface and a top surface curved in a direction away from the bottom surface 311 of the container body 310, the magnetized disk-shaped passive side ferromagnetic body 321b inserted into the interior space 321a1 of the base portion body 321a, the fixing screw 321c configured to fix the passive side ferromagnetic body 321b to the base portion body 321a, the flat plate 321d inserted into the recess portion 321b1 of the passive side ferromagnetic body 321b into which the protrusion portion 311b3 of the container body 310 is inserted, the seal member 321e interposed between the flat plate 321d and the fixing screw 321c, an annular flanged sliding bearing 321g press-fitted into the recess portion 321b1 of the passive side ferromagnetic body 321b, and an annular metal plate 321h interposed between the passive side ferromagnetic body 321b and the flanged sliding bearing 321g to form a bottom surface of the base portion 321.

The annular metal plate 321h is a flat plate made of a non-magnetic metal and is fixed to the base portion body 321a by abutting against a flange portion of the flanged sliding bearing 321g as illustrated in FIG. 9, etc.

Further, sealing is provided between the base portion body 321a and the annular metal plate 321h to prevent liquid seasonings and the like from entering therebetween.

### <1.3. Annular Resin Plate>

The annular resin plate 330 is made of a resin (e.g., PEEK resin) excellent in heat resistance, food safety, and sliding properties and is detachably attached around the protrusion portion 311b3 of the container body 310 as illustrated in FIG. 8B.

As illustrated in FIG. 8B, etc., the annular resin plate 330 abuts against the stir member 320 while the stir member 320 is attached to the container body 310.

Thus, when the stir member 320 rotates independently of the container body 310, the annular metal plate 321h of the stir member 320 slides against the annular resin plate 330.

### <2. Effects>

According to the automated cooking device 10 thus configured according to the second embodiment, in addition to the effects produced by the automated cooking device 10 according to the first embodiment, the protrusion portion 311b3 inserted into the recess portion 321b1 of the stir member 320 is formed on the bottom surface 311 of the container body 310 and the annular resin plate 330 configured to slide with the stir member 320 is detachably attached around the protrusion portion 311b3 of the container body 310, thereby reducing the sliding resistance between the container body 310 and the stir member 320, and thus the stir member 320 can be rotated more reliably and at a higher speed relative to the container body 310.

Further, the annular resin plate 330 is detachably attached around the protrusion portion 311b3 of the container body 310, so that the annular resin plate 330 can be easily replaced when the annular resin plate 330 becomes worn, which not only improves the maintainability of the cooking container 300 but also makes it easier to detach the annular resin plate 330 from the container body 310 to clean the cooking container 300, making it possible to keep the cooking container 300 cleaner.

### <Variants>

The automated cooking device according to some embodiments of the present invention has been described above, but the automated cooking device according to the present invention is not limited to the automated cooking device 10 according to the embodiments as described above.

For example, in the above embodiments, on each of the driving side ferromagnetic body 225a of the container holding unit 200 and the passive side ferromagnetic body 321b of the cooking container 300, four pairs of north and south poles are circumferentially arranged, but the number of north poles and south poles may be any as long as it is possible to configure a magnetic coupling mechanism between the driving side ferromagnetic body 225a of the container holding unit 200 and the passive side ferromagnetic body 321b of the cooking container 300.

For example, in the above embodiments, the container rotating shaft 222 of the container holding unit 200 is provided with the anti-rotation protrusion 222a1 and the container body 310 of the cooking container 300 is provided with the anti-rotation recess groove 311b2, but the container rotating shaft 222 of the container holding unit 200 may be provided with an anti-rotation recess groove and the container body 310 of the cooking container 300 may be provided with an anti-rotation protrusion.

Further, in the present embodiment, two pairs of anti-rotation protrusion and anti-rotation recess groove are provided, but one pair may be provided or three or more pairs may be provided.

For example, in the second embodiment as described above, the annular metal plate 321h of the stir member 320 slides against the annular resin plate 330, but without providing the annular metal plate 321h, at least one of the base portion body 321a and the passive side ferromagnetic body 321b of the stir member 320 may slide against the annular resin plate 330.

### REFERENCE SIGNS LIST

10 automated cooking device
100 cooking counter
100A top surface
110 caster
120 sink
130 plate table
131 board for plating
132 board storage member
200 container holding unit
210 base portion
220 pivot portion
221 housing
222 container rotating shaft
222a flange portion
222a1 anti-rotation protrusion
223 oil seal
224 first drive unit
224a timing pulley
224b timing belt
225 stir member rotating shaft
225a driving side ferromagnetic body
226 second drive unit
226a timing pulley
226b timing belt
230 handle
300 cooking container
310 container body
311 bottom surface
311a magnetic region
311b non-magnetic member (non-magnetic region)
311b1 tubular portion
311b2 anti-rotation recess groove
311b3 protrusion portion
312 side surface
312a cylindrical surface
312b inclined surface
313 spherical body
314 spherical body fixing member
320 stir member
321 base portion
321a base portion body
321a1 interior space
321b passive side ferromagnetic body
321b1 recess portion
321c fixing screw
321d flat plate
321e seal member
321f sliding bearing
321g flanged sliding bearing
321h annular metal plate
322 spatula
330 annular resin plate
400 container heating unit
410 top plate
420 induction heating coil
500 container washing unit
600 scraping unit
700 cover
800 control unit
810 control panel
820 emergency stop button
F floor surface
I ingredient
MF magnetic attractive force
MC1 magnetic circuit formed between container holding unit and stir member
MC2 magnetic circuit formed between container body and container heating unit
AC container body central axis

1. An automated cooking device comprising: a cooking container including a bottomed cylindrical container body configured to contain an ingredient and a stir member configured to stir the ingredient contained in the container body; and a container holding unit configured to rotatably hold the cooking container, the automated cooking device being configured to stir and cook the ingredient contained in the cooking container, characterized in that
the container holding unit has a container rotating shaft configured to engage with the container body of the cooking container to transmit a container rotation torque to the container body to cause the container body to rotate around a container body central axis and a stir member rotating shaft configured to rotate independently of the container rotating shaft, and
a magnetic coupling mechanism configured to transmit a stir member rotation torque in a non-contact manner between the stir member rotating shaft of the container holding unit and the stir member of the cooking container is formed.

2. The automated cooking device according to claim 1, characterized in that a protrusion portion inserted into a recess portion of the stir member is formed on a bottom surface of the container body, and
an annular resin plate configured to slide against the stir member is detachably attached around the protrusion portion of the container body.

3. The automated cooking device according to claim 1, characterized in that one of the container body of the cooking container and the container rotating shaft of the container holding unit is provided with an anti-rotation protrusion, and the other of the container body of the cooking container and the container rotating shaft of the container holding unit is provided with an anti-rotation recess groove configured to engage with the anti-rotation protrusion.

4. The automated cooking device according to any one of claim 1 to claim 3, characterized in that the container body of the cooking container is formed by a side surface made of a magnetic material and configured to be inductively heated from a container heating unit and a bottom surface including a non-magnetic region.
